(19) United States
(12) Patent Application Publication
(10) Pub. No.: US 2008/0095178 A1
(43) Pub. Date: Apr. 24, 2008

(54) Metaprotocol for Network Communications

(75) Inventors: Kevin HAWKINS, Fort Orange, FL (US); Thomas Player, Daytona Beach, FL (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Raydon Corporation, Daytona Beach, FL (US)

(21) Appl. No.: 11/871,872

(22) Filed: Oct. 12, 2007

Related U.S. Application Data
(60) Provisional application No. 60/851,065, filed on Oct. 12, 2006.

(51) Int. Cl. H04L 12/28

(52) U.S. Cl. 370/400

(57) ABSTRACT

A system and method that allows nodes of a distributed node network to publish messages to other nodes or objects, where the messages may have different protocols. The protocols are pre-established in advance of transmission, so that any given message can be sent as necessary to a subscribing node, where the subscribing node is equipped to receive the message, even though the message may have a particular associated protocol. Prior to passing messages, the nodes swap publishing tables. This allows each node to know in advance what messages can be expected and what protocol a message will have.

This application claims the benefit of U.S. Provisional Application 60/851,065, filed Oct. 12, 2006, and incorporated herein by reference in its entirety.

### BACKGROUND OF THE INVENTION

1. Field of the Invention

The invention described herein relates to communications systems, and in particular, to message protocols.

2. Related Art

Data networks are often heterogenous, in that different nodes may be configured differently, operate using different computing platforms, and/or support different communications protocols. Moreover, different messages may have their own protocols that must be processed and accommodated when passing from node to node in a network. This can make communication among nodes problematic.

Traditional solutions are inflexible and expensive to implement. For example, a common set of protocols could be defined, but would have to be implemented system wide, for all nodes and all messages. Another alternative would be to make sure that any two nodes needing to communicate share a common protocol. A message going from one node to another would use such a protocol, but passing the message to a third node might require yet another protocol. This in turn would require that the message be translated into a new protocol before being sent to the third node. Such a translation process might require additional software, hardware, or both.

In any event, conventional approaches to handling multiple protocols tend to be expensive and may hinder performance. Machines must be reconfigured, and messages may have to be converted from one protocol to another.

There is therefore a need for a system and method through which a network's nodes can cheaply and easily process messages that have different protocols, such that the network as a whole operates efficiently.

### BRIEF DESCRIPTION OF THE FIGURES

FIG. 1 is a flow chart illustrating how a node joins a distributed node network, according to an embodiment of the invention.

FIG. 2 is a flow chart illustrating group node initialization, according to an embodiment of the invention.

FIG. 3 is flow chart illustrating the processing of publishing table entries at a receiving node, according to an embodiment of the invention.

FIG. 4 is a dataflow diagram illustrating the operation of a distributed node network, according to an embodiment of the invention.

FIG. 5 is a block diagram illustrating the computing context of an embodiment of the invention.

Further embodiments, features, and advantages of the present invention, as well as the operation of the various embodiments of the present invention, are described below with reference to the accompanying drawings.

### DETAILED DESCRIPTION OF THE INVENTION

A preferred embodiment of the present invention is now described with reference to the figures, where like reference numbers indicate identical or functionally similar elements. Also in the figures, the leftmost digit of each reference number corresponds to the figure in which the reference number is first used. While specific configurations and arrangements are discussed, it should be understood that this is done for illustrative purposes only. A person skilled in the relevant art will recognize that other configurations and arrangements can be used without departing from the spirit and scope of the invention. It will be apparent to a person skilled in the relevant art that this invention can also be employed in a variety of other systems and application.

The system and method described herein allows nodes of a distributed node network to publish messages to other nodes or objects, where the messages may have different protocols. The protocols are pre-established in advance of transmission, so that any given message can be sent as necessary to a subscribing node, where the subscribing node is equipped to receive the message, even though the message may have a particular associated protocol. Prior to passing messages, the nodes swap publishing tables. This allows each node to know in advance what message(s) can be expected and what protocol the message(s) will have.

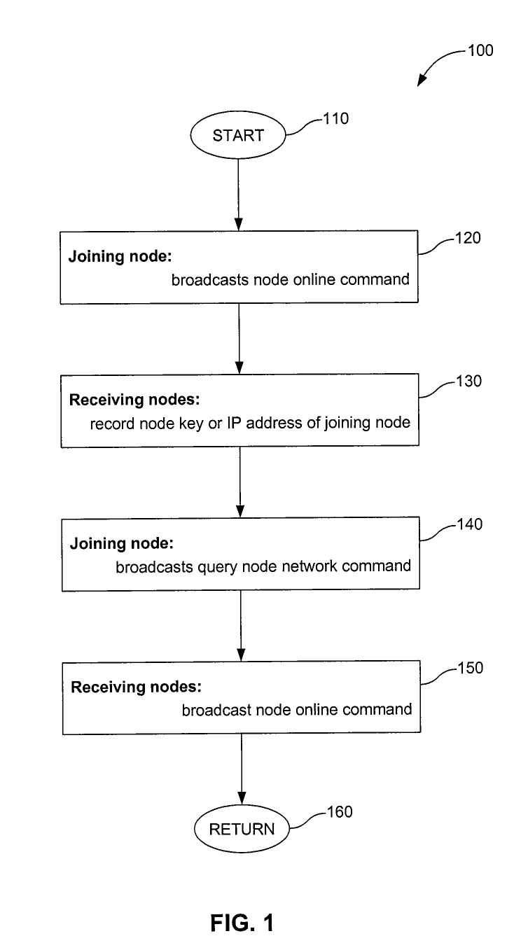

FIG. 1 illustrates the process by which a node joins a network, according to an embodiment of the invention. The process begins at step 110. At step 120, the joining node broadcasts a “node online” command to announce its presence to other nodes of the network. In step 130, each node that receives the node online command records the internet protocol (IP) address, node key, or other identifier of the joining node. In step 140, the joining node broadcasts a “query node network” command. This tells the other nodes in the network to rebroadcast the above node online command (step 150). The method of FIG. 1 therefore allows nodes of the network to become aware of a new joining node and its identifying information.

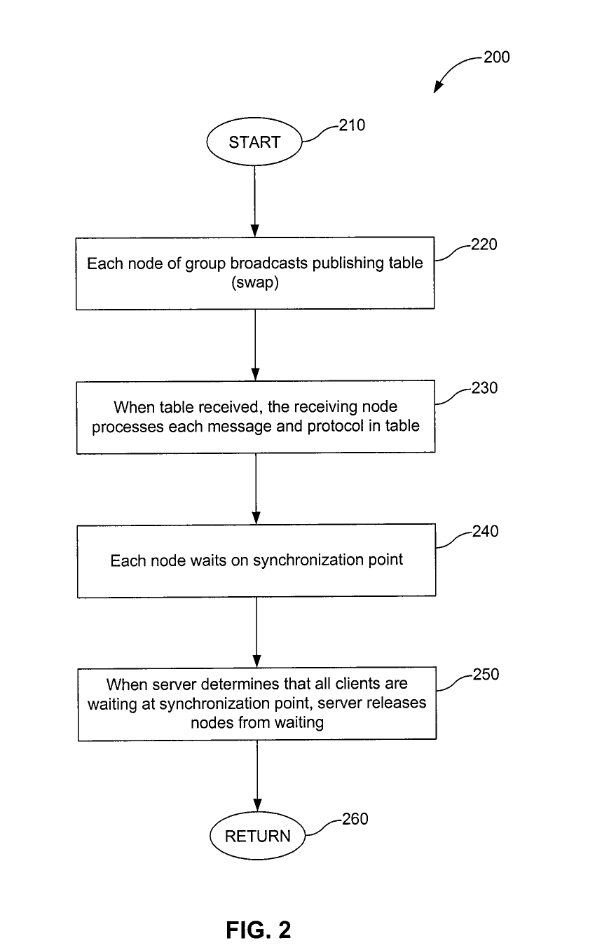

FIG. 2 illustrates a process by which nodes in the distributed node network become aware of messages that may have to be passed through the network, where respective protocols are associated with the messages, according to an embodiment of the invention. In this process, selected nodes are launched as a group. This process can be viewed as group node initialization. The group is assigned a multicast address and ports. The nodes defined in the group switch from a peer-to-peer configuration to a client-server configuration, where one node is designated as the server while the others are designated as the clients.

It should first be understood that a message protocol may consist of a message name and input/output parameters. The message name may be unique. Each input or output parameter may consist of a data type and an identifier. The following are examples of message protocols:

EXAMPLE_MESSAGE: a unique name.

EXAMPLE_MESSAGE or EXAMPLE_MESSAGE(void)(void): message with no defined input parameters or output parameters.

EXAMPLE_MESSAGE(short entityID): message with one input parameter, entityID, of type “short.”

EXAMPLE_MESSAGE(void)(short entityID): message with no input parameter, and one output parameter, entityID, of type “short.”

EXAMPLE_MESSAGE(short entityID)(double prevXPos, double prevYPos, double prevZPos): message with one input parameter, entityID, of type “short.” This message also has three output parameters, prevXPos, prevYPos, and prevZPos. The output parameters are all of type “double.”

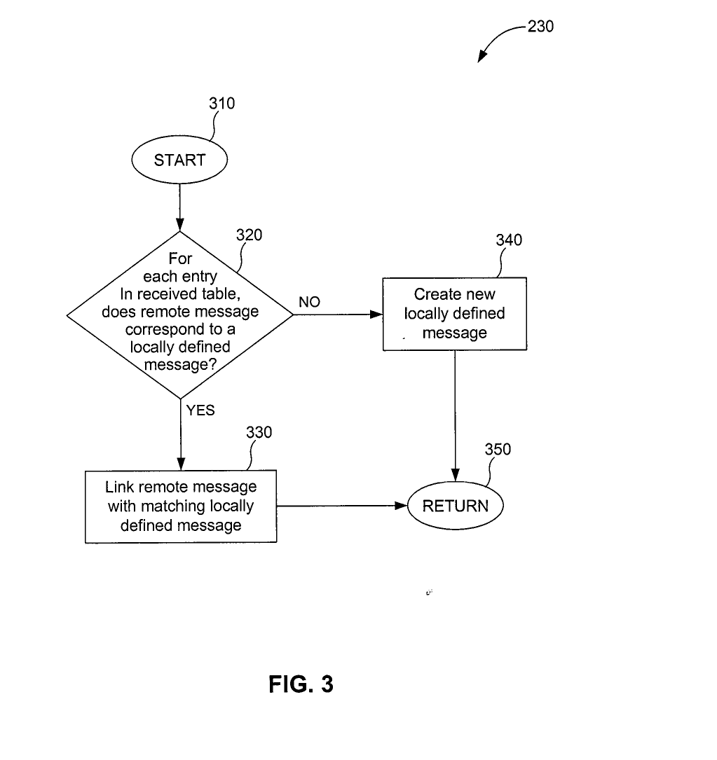

The process of FIG. 2 begins with step 210. At step 220, each node of the network or group broadcasts its publishing table. At a network level, this can be viewed as a swapping of publishing tables. The publishing table represents the distributed messages (with their respective protocols) that the node will publish on to the group's multicast network. In step 230, when a node receives a publishing table, the receiving node processes each message protocol defined in the publishing table. This step serves to make sure that the receiving node is prepared to receive messages of the types indicated in the table. The processing of step 220 is described in greater detail below with respect to FIG. 3. In step 240, each node waits at a synchronization point. In step 250, when the server node determines that all clients are waiting at the synchronization point, the server node releases the nodes from their waiting state. At this point, messaging between clients can now proceed asynchronously.

FIG. 3 illustrates in greater detail the processing of a received publishing table (step 230 above). Processing begins at step 310. In step 320, a determination is made as to whether, for each entry in the received table, the entry (i.e., a remote message) corresponds to a locally defined message. This represents a determination by the receiving node as to whether it is aware of a given message (and its protocol) listed in the received table. If, for an entry in the table, the remote message does not correspond to a locally defined message, the process continues at step 340. Here, a new message is created at the receiving node, where the new message corresponds to the remote message. As a result, the receiving node now has a message that corresponds to the remote message. If, for an entry in the table, the remote message does correspond to a locally defined message, the process continues at step 330. Here, the remote message is matched to a locally defined message that already exists at the receiving node. It is therefore not necessary to create a matching message, since one is already present in the receiving node. The process concludes at step 350.

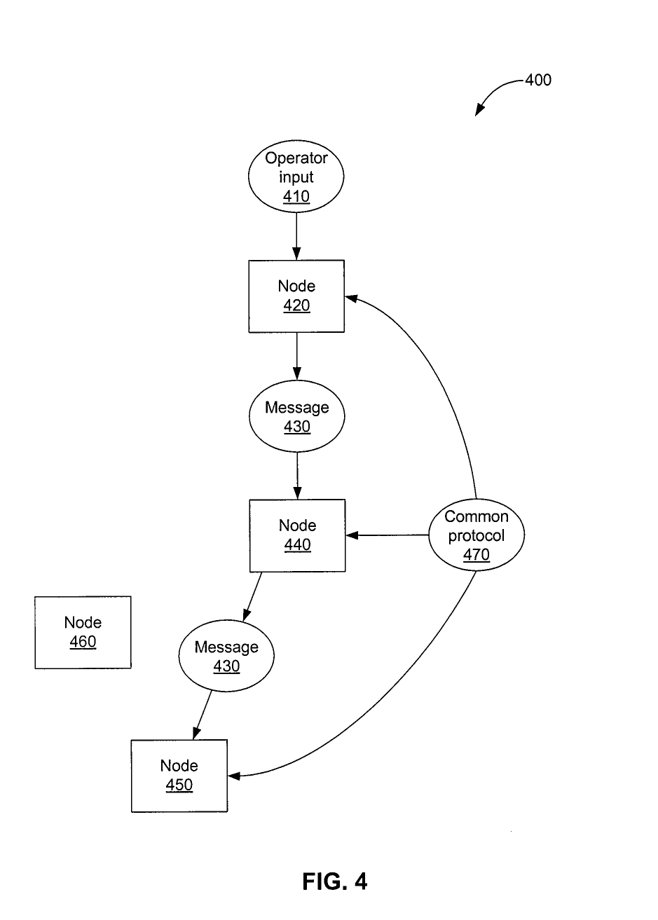

Once group node initialization is completed, operational distribution of messages can take place. An example of this operation, according to an embodiment of the invention, is illustrated in FIG. 4. In this example, the nodes in a distributed message network process and relay a message on the basis of an operator input 410. Such an arrangement could be used, for example, in a training simulation system where a student provides input to a simulated control (e.g., a trigger on a simulated weapon) that is monitored by a computer or software module such as node 420. Input 410 results in a message 430. If node 440 is intended to receive message 430, i.e., subscribes to message 430, this message is sent to node 440. Continuing with the training system example, node 440 may, for example, represent a computer and/or software module that generates a display image on the basis of the student's actions, e.g. the trigger pull of a simulated weapon. Note that the communication of message 430 from node 420 to node 440 is possible only because both of these nodes are capable of processing message 430 and its protocol 470. This sharing of common protocol 470 was effected by the group node initialization process shown in FIGS. 2 and 3. Note also that node 420 may send this message to one or more other nodes as well (not shown), such as computers and/or software modules responsible for generating sound that corresponds to weapon firing, if such nodes subscribe to this message, and if common protocol 470 is present at these additional nodes.

Second node 440 can then send message 430 on to one or more other nodes, such as node 450, again because node 450 subscribes to this message. Moreover, node 440 and node 450 have protocol 460 in common as a result of the group node initialization process. In may be that not all nodes subscribe to every message. In the illustrated example, node 460 does not receive message 430, since node 460 is not a subscriber to this message.

The logic described above can be implemented in software, hardware, firmware, or any combination thereof.

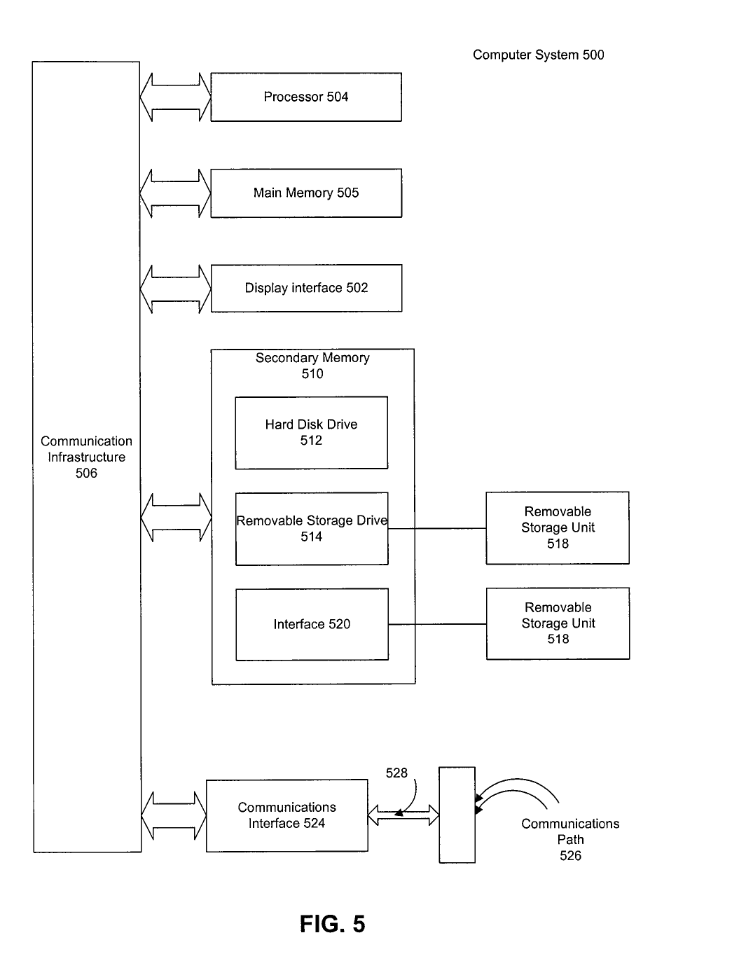

In an embodiment of the present invention, the system and components of the present invention described herein are implemented using well known computer systems at each of the nodes, such as a computer system 500 shown in FIG. 5. The computer system 500 can be any commercially available and well known computer system capable of performing the functions described herein, such as computers available from International Business Machines, Apple, Silicon Graphics Inc., Sun, HP, Dell, Compaq, etc.

The computer system 500 includes one or more processors (also called central processing units, or CPUs), such as a processor 504. The processor 504 is connected to a communication infrastructure 506, such as a bus. The computer system 500 also includes a main or primary memory 508, such as random access memory (RAM). The primary memory 508 has stored therein control logic (computer software), and data.

The computer system 500 also includes one or more secondary storage devices, shown as secondary memory 510. The secondary memory devices 510 include, for example, a hard disk drive 512, a removable storage device or drive 514, and/or any other type of interface 520 for a removable storage medium. The removable storage drive 514 represents a floppy disk drive, a magnetic tape drive, a compact disk drive, an optical storage device, tape backup, etc.

The removable storage drive 514 interacts with a removable storage unit 518. The removable storage unit 518 includes a computer useable or readable storage medium having stored therein computer software (control logic) and/or data. Removable storage unit 518 represents a floppy disk, magnetic tape, compact disk, DVD, optical storage disk, or any other computer data storage device. The removable storage drive 514 reads from and/or writes to the removable storage unit 518 in a well known manner.

The computer system 500 may also include input/output/display devices 530, such as monitors, keyboards, pointing devices, etc. A display 530 would connect to system 500 through a display interface 502.

The computer system 500 further includes a communication or network interface 524. The network interface 524 enables the computer system 500 to communicate with remote devices. For example, the network interface 524 allows the computer system 500 to communicate over communication networks or media, shown as communications path 526 (representing a form of a computer useable or readable medium), such as LANs, WANs, the Internet, etc. The network interface 524 may interface with remote sites or networks via wired or wireless connections. In an embodiment of the invention, a node may include a computer system such as system 500. Communications with other nodes can take place via communications path 526. These communications would include, for example, sending and receiving publication tables, node online commands, and query node network commands. This would allow the processor 504 to then perform the processes shown in FIGS. 2 and 3, for example.

Control logic may be transmitted to and from the computer system 500 via the communication medium 526. More particularly, the computer system 500 may receive and transmit carrier waves (electromagnetic signals) modulated with control logic via the communication medium 526.

Any apparatus or manufacture comprising a computer useable or readable medium having control logic (software) stored therein is referred to herein as a computer program product or program storage device. This includes, but is not limited to, the computer system 500, the main memory 508, the hard disk 512, and the removable storage unit 518. Such computer program products, having control logic stored therein that, when executed by one or more data processing devices, cause such data processing devices to operate as described herein, represent embodiments of the invention.

The invention can work with software, hardware, and/or operating system implementations other than those described herein. Any software, hardware, and operating system implementations suitable for performing the functions described herein can be used.

While some embodiments of the present invention have been described above, it should be understood that it has been presented by way of examples only and not meant to limit the invention. It will be understood by those skilled in the art that various changes in form and detail may be made without departing from the spirit and scope of the invention as defined in the specification and appended claim. Thus, the breadth and scope of the present invention should not be limited by the above-described exemplary embodiments, but should be defined only in accordance with the following claim and its equivalents.

What is claimed is:

1. A method of propagating information through a distributed network of nodes, the information regarding messages and protocols that will be passed in a network, the method comprising:
(a) receiving a publishing table broadcast by a node in the network, the publishing table comprising entries that each comprise a message name and a protocol definition; and
(b) for each entry in the publishing table,
(i) determining whether the entry represents a remote message and protocol that correspond to a local message and protocol;
(ii) if so, associating the remote message and protocol with the local message and protocol; and
(iii) if not, creating a new local message and protocol that corresponds to the remote message and protocol.

2. The method of claim 1, further comprising the following steps performed before step (a):
(a) (c) receiving a node online command from a joining mode:
(b) (d) recording an identifier of the joining node;
(c) (e) receiving a query node network command from the joining node; and
(d) (f) rebroadcasting the online command.

3. The method of claim 1 wherein the protocol definition comprises:
(a) any parameters associated with the message name; and
(b) indications of respective data types for the parameters.

4. A method of informing a plurality of nodes in a distributed node network of messages and protocols that will be passed in the network, the method comprising:
(a) broadcasting a publishing table comprising entries that each comprise a message name and a protocol definition.

5. The method of claim 4, further comprising the following steps performed before step (a):
(a) (b) broadcasting a node online command to each of the plurality of nodes; and
(b) (c) broadcasting a query node network command to each of the plurality of nodes.

6. The method of claim 4, wherein the protocol definition comprises:
(a) any parameters associated with the message name; and
(b) indications of respective data types for the parameters.

7. A communications node in a data network, the node comprising:
(a) a processor;
(b) a memory in communication with said processor, said memory configured to store a plurality of processing instructions for directing said processor to:
(c) receive a publishing table broadcast by a node in the network, the publishing table comprising entries that each comprise a message name and a protocol definition; and
(d) for each entry in the publishing table:
(i) determine whether the entry represents a remote message and protocol that correspond to a local message and protocol;
(ii) if so, associate the remote message and protocol with the local message and protocol; and
(iii) if not, create a new local message and protocol that corresponds to the remote message and protocol.

8. The communications node of claim 7 wherein said processing instructions further direct said processor to:
(a) (c) receive a node online command from a joining node;
(b) (d) record an identifier of the joining node;
(c) (e) receive a query node network command from the joining node
(d) (f) rebroadcast the online command.

9. The communications node of claim 7, wherein said protocol definition comprises:
(a) any parameters associated with the message name; and
(b) indications of respective types for the parameters.

10. A communications node in a data network, the node comprising:
(a) a processor; and
(b) a memory in communication with said processor, said memory configured to store a plurality of processing instructions for directing said processor to broadcast a publishing table comprising entries that each comprise a message name and a protocol definition.

11. The communications node of claim 10, wherein said processing instructions further direct said processor to:
(a) broadcast a node online command to each of the plurality of nodes; and
(b) broadcast a query node network command to each of the plurality of nodes.

12. The communications node of claim 10 wherein said protocol definition comprises:
(a) any parameters associated with the message name; and
(b) indications of respective types for the parameters.

13. A computer program product comprising a computer usable medium having control logic stored therein for causing a computer to propagate information through a distributed network of nodes, the information regarding messages and protocols that will be passed in the network, the computer control logic comprising:
(a) first computer readable program code names for causing the computer to receive a publishing table broadcast by a node in the network, the publishing table comprising entries that each comprise a message name and a protocol definition; and
(b) second computer readable program code names for causing the computer to, for each entry in the publishing table,
(i) determine whether the entry represents a remote message and protocol that correspond to a local message and protocol;
(ii) if so, associate the remote message with the local message; and
(iii) if not, create a new local message and protocol that corresponds to the remote message and protocol.

14. The computer program product of claim 13, further comprising:
(a) third computer readable program code names for causing the computer to receive a node online command from a joining node;
(b) fourth computer readable program code names for causing the computer to record an identifier of the joining node;
(c) fifth computer readable program code names for causing the computer to receive a query node network command from the joining node; and
(d) sixth computer readable program code names for causing the computer to rebroadcast the online command.

15. The computer program product of claim 13, wherein the protocol definition comprises:
(a) any parameters associated with the message name; and
(b) indications of respective types for the parameters.
